(19) United States
(12) Patent Application Publication
(10) Pub. No.: US 2023/0259968 A1
(43) Pub. Date: Aug. 17, 2023

(54) ELECTRONIC DEVICE FOR PROVIDING ADVERTISING INFORMATION, AND CONTROL METHOD THEREFOR

(71) Applicant: SAMSUNG ELECTRONICS CO., LTD., Suwon-Si (KR)

(72) Inventor: Yuseong JEON, Suwon-si (KR)

(73) Assignee: SAMSUNG ELECTRONICS CO., LTD., Suwon-Si (KR)

(21) Appl. No.: 18/134,925

(22) Filed: Apr. 14, 2023

Related U.S. Application Data
(63) Continuation of application No. PCT/KR2021/016296, filed on Nov. 10, 2021.

(30) Foreign Application Priority Data
Nov. 13, 2020 (KR) 10-2020-0151933

(51) Int. Cl. G06Q 30/0242

(52) U.S. Cl. CPC G06Q 30/0244

(57) ABSTRACT

An electronic device and a control method therefor. The electronic device comprising a communication unit, and a processor to receive information from a display device, from among a plurality of display devices, through the communication unit, the display device being configured to display an advertising campaign based on a user command input into the display device, identifying, based on the received information, whether a preset event involving the display of the advertising campaign on the display device has occurred, and transmitting information about a new advertising campaign through the communication unit so that the display device is provided with an updated advertising campaign, based on the present event being identified as having occurred.

### CROSS-REFERENCE TO RELATED APPLICATION(S)

This application is a continuation application, under 35 U.S.C. § 111(a), of international application No. PCT/KR2021/016296, filed on Nov. 10, 2021, which claims priority under 35 U. S. C. § 119 to Korean Patent Application No. 10-2020-0151933, filed on Nov. 13, 2020, the disclosures of which are incorporated herein by reference in their entirety.

### BACKGROUND

### Field

The disclosure relates to an electronic device and a control method therefor, and more particularly, to an electronic device providing an advertising campaign, and a control method therefor.

### Description of the Related Art

Recently, with the development of electronic technologies, the ratio of digital advertising in the advertising market is increasing. Digital advertising means exposing an advertising campaign to a user (or a consumer) by using various electronic devices as publishers, and the advertising campaign refers to various forms of information such as a message, an image, a moving image, etc. provided by an advertiser who purchased an advertisement area during a specific period for persuading or influencing the user (or the consumer).

Because of this, for a display device such as a television (TV), in addition to a conventional method that an advertising campaign is inserted between conventional broadcasting contents, a method that an advertising campaign is inserted in a partial area (i.e., an advertisement area) of an application or a user interface (UI) of the display device is becoming generalized.

In an environment wherein an advertisement area is fixed such as an application or a UI provided in a display device such as a TV, and the advertisement area can be exposed or disappear by a user manipulation, a method of displaying a stored advertising campaign in the advertisement area on the time point when the advertisement area is exposed to a user while the advertising campaign was received in advance from an advertisement server and stored is being used.

Meanwhile, in the case of the method that a display device stores an advertising campaign in advance, a valid term should be set for each advertising campaign. Here, in case a time point when an advertisement area is exposed to a user arrived after the valid term of the advertising campaign expired, the advertising campaign that was received in advance cannot be used as the valid term expired, and a new advertising campaign of which valid term did not expire should be received from an advertisement server, and thus there is a problem that time is spent until an effective advertising campaign is displayed in the advertisement area, and due to this, a problem that the opportunity that the advertising campaign is exposed to a user decreases occurs.

Meanwhile, for exposing a related advertising campaign during a specific event (e.g.: a sport season, an election, etc.) period on which users' attention is focused, there is a problem that a display device should receive an advertising campaign related to the event from an advertisement server and store the advertising campaign in advance before the period.

### SUMMARY

An electronic device according to an embodiment of the disclosure may include a communication unit, and a processor configured to receive information from a display device among a plurality of display devices through the communication unit, the display device being configured to display an advertising campaign based on a user command input into the display device, identify whether a preset event involving the display of the advertising campaign on the display device occurred based on the received information, and based on the preset event being identified as having occurred, transmit information about a new advertising campaign to the display device through the communication unit so that the display device is provided with an updated advertising campaign.

According to an embodiment, the electronic device may further include a memory to store information on valid terms for each of a plurality of advertising campaigns, respectively, and the processor may, based on identification information of the advertising campaign being received from the display device, identify a respective valid term of the advertising campaign among the valid terms of the plurality of advertising campaigns, and based on the respective valid term of the advertising campaign being identified and time information of a region in which the display device is located received from the display device, identify whether the preset event occurred in relation to the respective valid term of the advertising campaign.

According to an embodiment, the preset event may include an event that the respective valid term of the advertising campaign which is provided to the display device expired, and the processor may, based on the identified valid term of the advertising campaign and the time information of the region in which the display device is located received from the display device, identify whether the respective valid term of the advertising campaign expired, and based on the respective valid term of the advertising campaign being identified as expired, transmit the information about the new advertising campaign to the display device through the communication unit.

According to an embodiment, the preset event may include an event that a time point before a preset time from a time point when the respective valid term of the advertising campaign provided to the display device expires arrives, and the processor may, based on the respective valid term of the advertising campaign and the time information of the region in which the display device is located received from the display device, identify whether the time point arrived, and based on the time point being identified as having arrived, transmit the information about the new advertising campaign to the display device through the communication unit.

According to an embodiment, the preset event may include an event that the advertising campaign is displayed on the display device, and the processor may, based on receiving information indicating that the advertising campaign was displayed from the display device, identify that the event that the advertising campaign is displayed on the display device occurred, and transmit the information about the new advertising campaign to the display device through the communication unit.

According to an embodiment, the new advertising campaign may be a valid term that expires on a different time point from the advertising campaign provided to the display device.

According to an embodiment, the processor may identify whether a new advertising campaign set to be provided during a preset period exists among the plurality of advertising campaigns, and based on identifying that a time of the region in which the display device is located corresponds to the preset period based on the time information of the region in which the display device is located received from the display device, transmit the information about the new advertising campaign set to be provided during the preset period to the display device through the communication unit.

According to an embodiment, the processor may, based on receiving request information from the display device through the communication unit according to turning-on of the display device, identify whether the preset event involving the display of the advertising campaign on the display device occurred based on the received request information, and the request information may include identification information of the advertising campaign and time information of a region in which the display device is located.

A control method for an electronic device according to an embodiment of the disclosure may include receiving information from a display device among a plurality of display devices, the display device being configured to display an advertising campaign based on a user command input into the display device, identifying whether a preset event involving the display of the advertising campaign on the display device occurred based on the received information, and based on the preset event being identified as having occurred, transmitting information about a new advertising campaign to the display device so that the display device is provided with an updated advertising campaign.

According to an embodiment, the identifying whether the preset event occurred may include, based on identification information of an advertising campaign received from the display device, identifying a respective valid term of the advertising campaign among valid terms of each of the plurality of advertising campaigns that are stored in the electronic device, and based on the respective valid term of the advertising campaign being identified and time information of a region in which the display device is located received from the display device, identifying whether the preset event occurred in relation to the valid term of the advertising campaign.

According to an embodiment, the preset event may include an event that the respective valid term of the advertising campaign which is provided to the display device expired, and in the identifying whether the preset event occurred, based on the respective valid term of the advertising campaign and the time information of the region in which the display device is located received from the display device, it may be identified whether the valid term of the advertising campaign expired, and in the transmitting to the display device, based on the respective valid term of the advertising campaign being identified as expired, the information about the new advertising campaign may be transmitted to the display device.

According to an embodiment, the preset event may include an event that a time point before a preset time from a time point when the respective valid term of the advertising campaign provided to the display device expires arrives, and in the identifying whether the preset event occurred, based on the respective valid term of the advertising campaign and the time information of the region in which the display device is located received from the display device, it may be identified whether the time point arrived, and in the transmitting to the display device, based on the time point being identified as having arrived, the information about the new advertising campaign may be transmitted to the display device.

According to an embodiment, the preset event may include an event that the advertising campaign is displayed on the display device, and in the identifying whether the preset event occurred, based on receiving information indicating that the advertising campaign was displayed from the display device, it may be identified that the event that the advertising campaign is displayed on the display device occurred, and in the transmitting to the display device, the information about the new advertising campaign may be transmitted to the display device.

According to an embodiment, the new advertising campaign may have a valid term that expires on a different time point from the advertising campaign provided to the display device.

According to an embodiment, in the identifying whether the preset event occurred, it may be identified whether a new advertising campaign set to be provided during a preset period exists among the plurality of advertising campaigns, and in the transmitting to the display device, based on identifying that a time of the region in which the display device is located corresponds to the preset period based on the time information of the region in which the display device is located received from the display device, the information about the new advertising campaign set to be provided during the preset period may be transmitted to the display device.

According to an embodiment, in the identifying whether the preset event occurred, based on receiving request information from the display device according to turning-on of the display device, it may be identified whether the preset event involving the display of the advertising campaign on the display device occurred based on the received request information, and the request information may include identification information of the advertising campaign and time information of a region in which the display device is located.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A is a diagram for illustrating a system according to an embodiment of the disclosure;

FIG. 1B is a diagram for illustrating an advertising campaign exposed at a display device according to an embodiment of the disclosure;

FIG. 2A is a block diagram for illustrating a configuration of an electronic device according to an embodiment of the disclosure;

FIG. 2B is a block diagram for illustrating a configuration of a display device according to an embodiment of the disclosure;

FIG. 3 is a sequence diagram for illustrating operations of each device according to an embodiment of the disclosure;

FIG. 4A is a diagram for illustrating a preset event according to a valid term of an advertising campaign according to an embodiment of the disclosure;

FIG. 4B is a diagram for illustrating a preset event according to a valid term of an advertising campaign according to an embodiment of the disclosure;

FIG. 4C is a diagram for illustrating a preset event according to a valid term of an advertising campaign according to an embodiment of the disclosure;

FIG. 4D is a diagram for illustrating a preset event according to an event that an advertising campaign was exposed within the valid term of the advertising campaign according to an embodiment of the disclosure;

FIG. 5A is a diagram for illustrating a preset event according to an advertising campaign of a time target type according to an embodiment of the disclosure;

FIG. 5B is a diagram for illustrating a preset event according to an advertising campaign of a time target type according to an embodiment of the disclosure;

FIG. 6 is a diagram for illustrating detailed modules of each device according to an embodiment of the disclosure;

FIG. 7 is a diagram for illustrating additional components of an electronic device according to an embodiment of the disclosure; and

FIG. 8 is a diagram for illustrating a flow chart according to an embodiment of the disclosure.

### DETAILED DESCRIPTION

In describing the disclosure, in case it is determined that detailed explanation of related known functions or features may unnecessarily confuse the gist of the disclosure, the detailed explanation will be omitted. In addition, the embodiments below may be modified into several different forms, and the scope of the technical idea of the disclosure is not limited to the embodiments below. Rather, these embodiments are provided to make the disclosure more sufficient and complete, and to fully convey the technical idea of the disclosure to those of ordinary skill in the technical field to which the disclosure pertains.

Also, the various embodiments of the disclosure are not for limiting the technology described in the disclosure to a specific embodiment, but they should be interpreted to include various modifications, equivalents, and/or alternatives of the embodiments of the disclosure. Further, with reference to the detailed description of the drawings, similar components may be designated by similar reference numerals.

In addition, the expressions “first,” “second,” and the like used in the disclosure may be used to describe various elements regardless of any order and/or degree of importance. Also, such expressions are used only to distinguish one element from another element, and are not intended to limit the elements.

Further, in the disclosure, the expressions “A or B,” “at least one of A and/or B,” or “one or more of A and/or B” and the like may include all possible combinations of the listed items. For example, “A or B,” “at least one of A and B,” or “at least one of A or B” may refer to all of the following cases: (1) including at least one A, (2) including at least one B, or (3) including at least one A and at least one B.

Also, in the disclosure, singular expressions include plural expressions, unless defined obviously differently in the context. Further, in the disclosure, terms such as “include” and “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

In addition, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element). In contrast, the description that one element (e.g.: a first element) is “directly coupled” or “directly connected” to another element (e.g.: a second element) can be interpreted to mean that still another element (e.g.: a third element) does not exist between the one element and the another element.

Also, the expression “configured to” used in the disclosure may be interchangeably used with other expressions such as “suitable for,” “having the capacity to,” “designed to,” “adapted to,” “made to,” and “capable of,” depending on cases. Meanwhile, the term “configured to” does not necessarily mean that a device is “specifically designed to” in terms of hardware. Instead, under some circumstances, the expression “a device configured to” may mean that the device “is capable of” performing an operation together with another device or component. For example, the phrase “a processor configured to perform A, B, and C” may mean a dedicated processor (e.g.: an embedded processor) for performing the corresponding operations, or a generic-purpose processor (e.g., a CPU or an application processor) that can perform the corresponding operations by executing one or more software programs stored in a memory device.

The disclosure was devised for addressing the aforementioned and other need, and the purpose of the disclosure is in providing an electronic device providing an advertising campaign for being exposed to a user faster, and a control method therefor.

According to the various embodiments of the disclosure as described herein, an electronic device providing an advertising campaign for being exposed to a user faster, and a control method therefor can be provided.

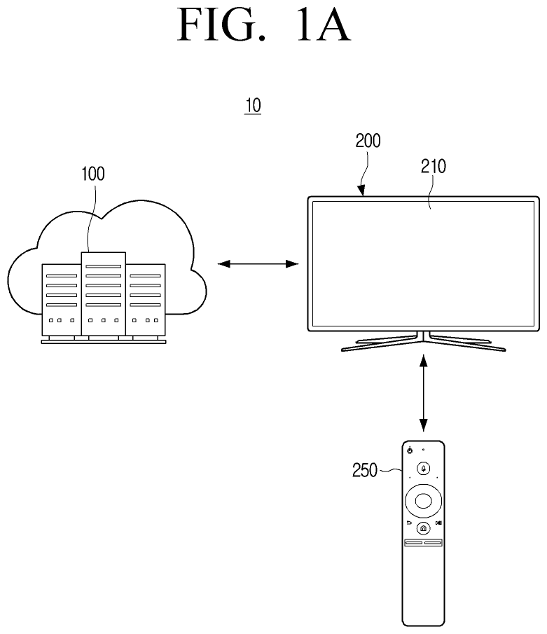

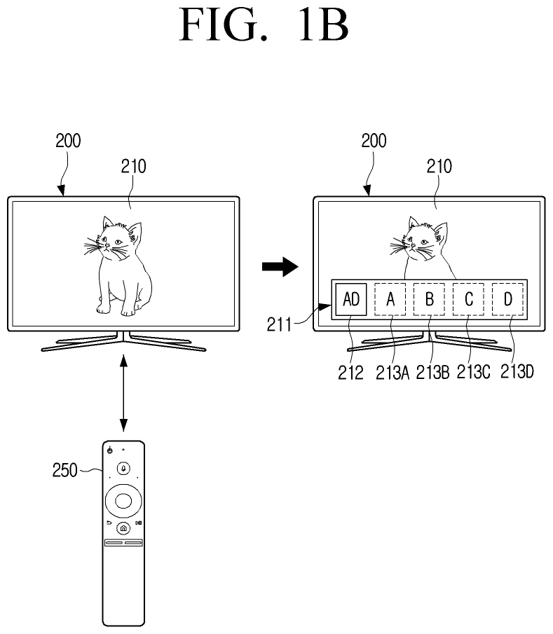

FIG. 1A is a diagram for illustrating a system according to an embodiment of the disclosure.

Referring to FIG. 1A, a system 10 according to an embodiment of the disclosure may include an electronic device 100 and a display device 200.

The electronic device 100 is a device that provides data related to advertising. Specifically, the electronic device 100 is a device for providing an advertising campaign displayed on the display device 200 based on a user command input into the display device 200. That is, the electronic device 100 may be connected with at least one display device 200 through a network and manage the at least one display device 200 connected through the network, and transmit information about an advertising campaign by an advertiser to the at least one display device 200. The advertising campaign refers to various forms of information such as a message, an image, a moving image, etc. provided by an advertiser who purchased an advertisement area during a specific period for persuading or influencing a user (or a consumer). Here, the electronic device 100 may transmit information about advertising campaigns of which valid terms are set for each advertising campaign to the display device 200.

A valid term refers to a period wherein an advertising campaign can be displayed on the display device 200, and the valid term may be implemented in various forms such as a period (e.g.: 10 minutes, 2 hours, etc.) or an expiration point (e.g.: 23:00 on Dec. 1, 2020, etc.), and the like. For example, in case the valid term is a period of two hours, an advertising campaign may be displayed on the display device 200 during a period until a time point of two hours after a preset time point (e.g.: the time point when the electronic device 100 transmitted information about the advertising campaign, the time point when the display device 200 received the information about the advertising campaign, the time point when the information about the advertising campaign was stored in the display device 200, etc.). Meanwhile, in case the valid term is an expiration point, the advertising campaign may be displayed on the display device 200 during a period before the expiration point.

The electronic device 100 according to the various embodiments of the disclosure may be implemented in a form such as a server, or it may also be implemented in an on-device form. For example, the electronic device 100 may be implemented as a rack mount-type server, a tower-type server, a cloud server, etc., but it may be implemented as various electronic devices without being limited to the types or the names. Also, the electronic device 100 may include at least one of a smartphone, a tablet personal computer (PC), a mobile phone, a video phone, an e-book reader, a desktop personal computer (PC), a laptop personal computer (PC), a netbook computer, a workstation, a personal digital assistant (PDA), a portable multimedia player (PMP), an MP3 player, a mobile medical device, a camera, or a wearable device. According to another embodiment, the electronic device 100 may be a home appliance. The home appliance may include, for example, at least one of a television, a digital video disk (DVD) player, an audio, a refrigerator, an air conditioner, a cleaner, an oven, a microwave oven, a washing machine, an air purifier, a set-top box, a home automation control panel, a security control panel, a TV box (e.g.: Samsung HomeSync™, Apple TV™, or Google TV™), a game console (e.g.: Xbox™, PlayStation™), an electronic dictionary, an electronic key, a camcorder, or an electronic photo frame.

The display device 200 may receive information on an advertising campaign of which valid term has been set from the electronic device 100 and store the information in the display device 200. Afterwards, the display device 200 may display the advertising campaign on the display 210 within the valid term set for the advertising campaign. A more detailed embodiment in this regard will be described with reference to FIG. 1B.

FIB. 1B is a diagram for illustrating an advertising campaign exposed at a display device according to an embodiment of the disclosure.

Referring to FIG. 1B, the display device 200 may perform an operation corresponding to a user's manipulation. Specifically, the display device 200 may perform an operation corresponding to a user's manipulation of the remote controller 250. However, this is merely an example, and the display device 200 may recognize a user's voice (or a user's motion, etc.) and perform an operation corresponding to the recognized voice (or the user's motion, etc.), or the display device 200 may perform an operation corresponding to a user's manipulation through a touch panel, a button, etc. provided on the display device 200.

For example, according to a user's manipulation, the display device 200 may change a broadcasting channel that receives a broadcasting content, change the volume of the speaker output from the display device 200, execute an application stored in the display device 200, or display a UI stored in the display device 200.

As an example, referring to FIG. 1B, the display device 200 may display a UI 211 corresponding to a user's manipulation in one area of the display 210 according to a user's manipulation (e.g.: a manipulation of pushing the home button of the remote controller 250, etc.). The UI 211 may include an advertisement area 212 wherein an advertising campaign is displayed and at least one UI element 213A to 213D. Here, the UI elements 213A to 213D may be selected according to the user's manipulation (e.g.: a manipulation of pushing a direction button and a selection button of the remote controller 250, etc.). When the UI elements 213A to 213D are selected according to the user's manipulation, the display device 200 may perform an operation (or an application) mapped to the selected UI elements 213A to 231D.

According to the user's manipulation (e.g.: a manipulation of pushing the home button of the remote controller 250, etc.), the display device 200 may display the advertisement area 212 included in the UI 211 corresponding to the user's manipulation on the display 210. Here, in case the UI 211 is displayed within the valid term set for the advertising campaign, the display device 200 may display the advertising campaign in the advertisement area 212 included in the UI 211 by using the information about the advertising campaign stored in the display device 200. Here, the information about the advertising campaign may include a network address (e.g.: a uniform resource locator (URL), an Internet protocol (IP) address, etc.) by which the user can access the advertising campaign. As described above, the display device 200 may expose an advertising campaign of an advertiser to a user.

According to an embodiment of the disclosure, in the display device 200, information about an advertising campaign of which valid term has been set may be stored in advance, and in such a method, a case wherein the valid term of the advertising campaign expires may inevitably occur. Hereinafter, an embodiment of updating an advertising campaign of which valid term has expired or is going to expire that is stored in the display device 200 to a new advertising campaign having a new valid term by using the electronic device 100, so that an advertising campaign can be displayed more effectively and quickly at the display device 200, will be described.

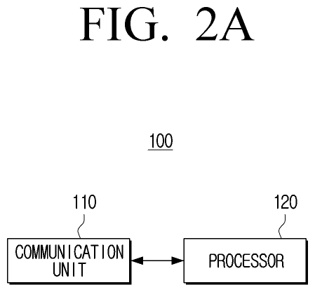

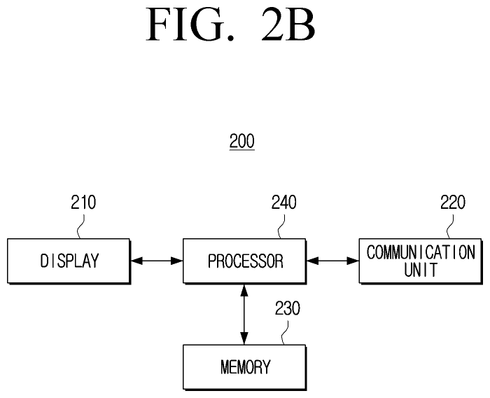

FIG. 2A is a block diagram for illustrating a configuration of an electronic device according to an embodiment of the disclosure.

Referring to FIG. 2A, the electronic device 100 may include a communication unit 110 and a processor 120.

The communication unit 110 may transmit data to various external devices, or receive data from various external devices. For example, the communication unit 110 may be connected with at least one display device 200 through a network. For this, the communication unit 110 may include a circuit for performing communication according to various communication methods (e.g.: a universal serial bus (USB), an Ethernet, optical communication, a Thunderbolt, wireless communication, etc.).

The processor 120 may control overall operations of the electronic device 100 or components included in the electronic device 100. Also, the processor 120 may perform an operation of processing data.

For this, the processor 120 may be implemented as a generic-purpose processor such as a central processing unit (CPU), an application processor (AP), etc., a graphic-dedicated processor such as a graphic processing unit (GPU), a vision processing unit (VPU), etc., an artificial intelligence-dedicated processor such as a neural processing unit (NPU), etc. That is, the processor 120 may be implemented as one of them, or a combination of them. Also, the processor 120 may include a volatile memory for loading at least one instruction or module.

The processor 120 may receive information from a display device 200 among a plurality of display devices 200 through the communication unit 110, identify whether a preset event occurred for an advertising campaign provided to the display device 200 based on the received information, and if it is identified that the preset event occurred, transmit information about a new advertising campaign to the display device 200 through the communication unit 110 so that the display device 200 updates the advertising campaign.

Specifically, the processor 120 may receive information from the display device 200 among the plurality of display devices 200 through the communication unit 110.

Here, if request information is received from the display device 200 through the communication unit 110 according to turning-on of the display device 200, the processor 120 may identify whether a preset event occurred regarding the advertising campaign provided to the display device 200 based on the received request information. In this case, the request information may include identification information of the advertising campaign and time information of a region wherein the display device 200 is located.

Then, the processor 120 may identify whether the preset event occurred for the advertising campaign provided to the display device 200 based on the received information.

Then, if it is identified that the preset event occurred, the processor 120 may transmit information about a new advertising campaign to the display device 200 through the communication unit 110 so that the display device 200 updates the advertising campaign.

Here, the new advertising campaign may be an advertising campaign having a valid term that expires on a different time point from the advertising campaign provided to the display device 200. Meanwhile, a computing point and an expiration point of a valid term may be different from each other for each advertising campaign, but a period between a computing point and an expiration point (e.g.: 30 minutes, 4 hours, etc.) may all be the same period. However, this is merely an example, and it is also possible that the period is set as a different period from each other for each advertising campaign.

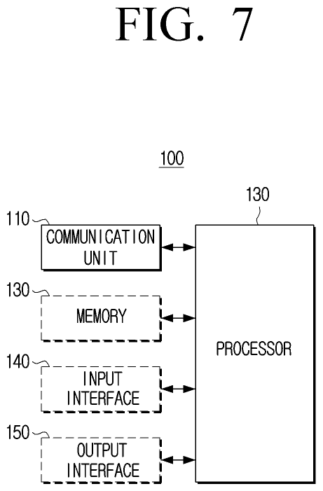

According to an embodiment, the electronic device 100 may further include a memory 130 (refer to FIG. 7) storing information on valid terms for each of a plurality of advertising campaigns. In this case, the processor 120 may identify a valid term of an advertising campaign among the valid terms for each of the plurality of advertising campaigns based on identification information of the advertising campaign received from the display device 200. The processor 120 may identify whether the preset event related to the valid term of the advertising campaign occurred based on the identified valid term of the advertising campaign and the time information of the region wherein the display device 200 is located received from the display device 200.

According to an embodiment, the preset event may include an event that the valid term of the advertising campaign provided to the display device 200 expired. In this case, the processor 120 may identify whether the valid term of the advertising campaign expired based on the identified valid term of the advertising campaign and the time information of the region wherein the display device 200 is located received from the display device 200. Then, if it is identified that the valid term of the advertising campaign expired, the processor 120 may transmit the information about the new advertising campaign to the display device 200 through the communication unit 110.

According to an embodiment, the preset event may include an event that a time point before a preset time from a time point when the valid term of the advertising campaign provided to the display device 200 expires arrives. In this case, the processor 120 may identify whether the time point arrived based on the identified valid term of the advertising campaign and the time information of the region wherein the display device 200 is located received from the display device 200. Then, if it is identified that the time point arrived, the processor 120 may transmit the information about the new advertising campaign to the display device 200 through the communication unit 110.

According to an embodiment, the preset event may include an event that the advertising campaign is displayed on the display device 200. In this case, if information indicating that the advertising campaign was displayed is received from the display device 200, the processor 120 may identify that the event that the advertising campaign is displayed on the display device 200 occurred. Then, the processor 120 may transmit the information about the new advertising campaign to the display device 200 through the communication unit 110.

According to an embodiment, the processor 120 may identify whether a new advertising campaign set to be provided during a preset period exists among the plurality of advertising campaigns. Then, if it is identified that the time of the region wherein the display device 200 is located corresponds to the preset period based on the time information of the region wherein the display device 200 is located received from the display device 200, the processor 120 may transmit the information about the new advertising campaign set to be provided during the preset period to the display device 200 through the communication unit 110.

FIG. 2B is a block diagram for illustrating a configuration of a display device according to an embodiment of the disclosure.

Referring to FIG. 2B, the display device 200 may include a display 210, a communication unit 220, a memory 230, and a processor 240.

The display 210 is a device that provides information to a user visually by outputting an image. The display 210 may display an image in one area or the entire area of the display 210. At least a part of the display 210 may be combined with at least one of the front surface area, the side surface areas, or the rear surface area of the display device 200 in the form of a flexible display. The flexible display may be characterized in that it can be bent, curved, or rolled without a damage through a substrate which is thin and flexible like paper.

The communication unit 220 may transmit data to various external devices, or receive data from various external devices. For example, the communication unit 220 may be connected with the electronic device 100 through a network, and receive information (or data) from the electronic device 100, or transmit information (or data) to the electronic device 100. For this, the communication unit 220 may include a circuit for performing communication according to various communication methods (e.g.: a universal serial bus (USB), an Ethernet, optical communication, a Thunderbolt, wireless communication, etc.).

Also, the communication unit 220 may perform communication with an external device such as a remote controller 250, etc., and transmit an instruction corresponding to a user's manipulation through the remote controller 250 to the processor 240.

The memory 230 is a component for storing an operating system (OS, e.g.: Tizen, etc.) for controlling the overall operations of the components of the display device 200, and various kinds of data related to the components of the display device 200. For this, the memory 230 may consist of hardware that temporarily or permanently stores data or information. For example, the memory 230 may be implemented as at least one hardware among a non-volatile memory, a volatile memory, a flash memory, a hard disk drive (HDD) or a solid state drive (SSD), a RAM, a ROM, etc.

In the memory 230, information about an advertising campaign received from the electronic device 100 may be stored.

The processor 240 may control the overall operations of the display device 200 or components included in the display device 200. Also, the processor 240 may perform an operation of processing data or image data.

For this, the processor 240 may be implemented as a generic-purpose processor such as a central processing unit (CPU), an application processor (AP), etc., a graphic-dedicated processor such as a graphic processing unit (GPU), a vision processing unit (VPU), etc., an artificial intelligence-dedicated processor such as a neural processing unit (NPU), etc. That is, the processor 240 may be implemented as one of them, or a combination of them. Also, the processor 240 may include a volatile memory for loading at least one instruction or module.

If the display device 200 is turned on, the processor 240 may control the communication unit 220 to transmit request information to the electronic device 100. Here, the request information may include at least one of the identification information (identifier; ID) of the display device 200, the network address of the display device 200, information on the advertisement area 212 exposed at the display device 200 (the size of the advertisement area 212, etc.), information on the region wherein the display device 200 is located, time information of the region wherein the display device 200 is located, or information about an advertising campaign stored in the display device 200 (e.g.: identification information (ID) of the advertising campaign, the valid term, etc.).

If a user command is received, the processor 240 may control the display device 200 to perform an operation corresponding to the user command. As an example, if a user command for calling the UI 211 is received, the processor 240 may control the display 210 to display the UI 211 corresponding to the user command in one area of the display 210.

Here, by using the information about the advertising campaign stored in the memory 230, the processor 240 may control the display 210 to display the advertising campaign in the advertisement area 212 included in the UI 211 in case the time point when the user command for calling the UI 211 was received is before the valid term set for the advertising campaign expires. Unlike this, by using the information about the advertising campaign stored in the memory 230, the processor 240 may control the display 210 to not display the advertising campaign in the advertisement area 212 included in the UI 211 in case the time point when the user command for calling the UI 211 was received is after the valid term set for the advertising campaign expired.

Meanwhile, the display device 200 may further include a speaker, and the speaker may directly output not only various kinds of audio data for which various processing jobs such as decoding or amplification, and noise filtering were performed by an audio processor (not shown), but also various kinds of notification sounds or voice messages as sounds.

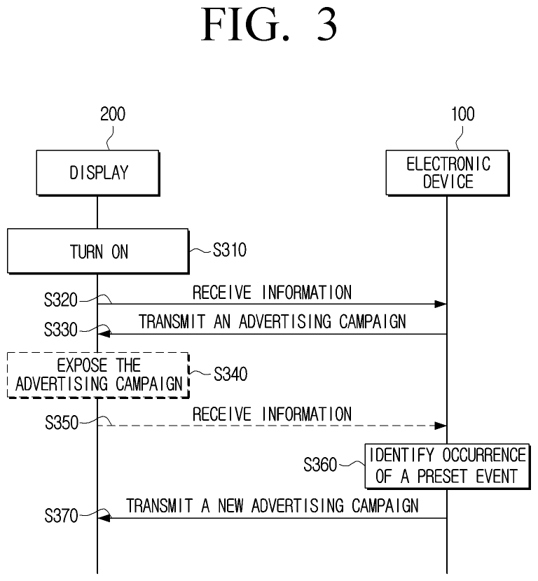

FIG. 3 is a sequence diagram for illustrating operations of each device according to an embodiment of the disclosure.

Referring to FIG. 3, the display device 200 may be turned on according to a user manipulation in operation S310. The display device 200 may transmit request information for registration of the display device 200 to the electronic device 100 according to the turning-on in operation S320. Here, the request information may include at least one of the identification information (identifier; ID) of the display device 200, the network address of the display device 200, the information on the advertisement area 212 exposed at the display device 200 (the size of the advertisement area 212, etc.), information on the region wherein the display device 200 is located, or time information of the region wherein the display device 200 is located.

Based on the request information received from the display device 200, the electronic device 100 may transmit the information about the advertising campaign of which valid term has been set to the display device 200 in operation S330. The information about the advertising campaign may include at least one of the network address through which the advertising campaign can be accessed, the valid term during which the advertising campaign can be accessed through the network address, the size of the advertising campaign, or information indicating whether a time targe type has been set for the advertising campaign.

Afterwards, the electronic device 100 may identify whether a preset event occurred based on the request information received from the display device 200 in operation S360.

Here, the preset event may include at least one of an event that the advertising campaign is displayed on the display device 200, an event that the valid term of the advertising campaign provided to the display device 200 expired, an event that a time point before a preset time (e.g.: 30 seconds, 5 minutes, etc.) from a time point when the valid term of the advertising campaign provided to the display device 200 expired arrives, or an event that a time point within a preset period arrived for an advertising campaign of a time target type.

According to an embodiment, in case an event that the advertising campaign is displayed in the advertisement area 212 included in the UI 211 occurred according to a user command within the valid term at the display device 200 in operation S340, the display device 200 may transmit information indicating that the advertising campaign was displayed to the electronic device 100. In this case, if information indicating that the advertising campaign was displayed is received from the display device 200, the electronic device 100 may identify that an event that the advertising campaign is displayed on the display device 200 occurred. That is, if information indicating that the advertising campaign was displayed is received from the display device 200, the electronic device 100 may identify that the preset event occurred.

According to an embodiment, an event that the valid term of the advertising campaign provided to the display device 200 expires while the advertising campaign is not displayed in the advertisement area 212 included in the UI 211 may occur.

In this case, the electronic device 100 may identify whether an event that the valid term of the advertising campaign expired occurred, based on the valid term of the advertising campaign stored in the display device 200 received from the display device 200 and the time information of the region wherein the display device 200 is located received from the display device 200.

For example, the electronic device 100 may calculate a difference (e.g.: 3 hours) between the time when the information was received from the display device 200 (e.g.: 12:00 based on the electronic device 100) and the current time (e.g.: 15:00 based on the electronic device 100), and add the calculated difference (e.g.: 3 hours) to the time information (e.g.: 16:00) of the region (e.g.: Seoul) wherein the display device 200 is located when the information was received from the display device 200, and calculate the current time (e.g.: 19:00) of the region wherein the display device 200 is located. The electronic device 100 may identify whether the valid term of the advertising campaign expired based on the current time of the region wherein the display device 200 is located.

Then, if it is identified that the valid term of the advertising campaign expired based on the current time of the region wherein the display device 200 is located, the electronic device 100 may identify that the preset event occurred.

According to an embodiment, an event that a time point before a preset time (e.g.: 30 seconds, 5 minutes, etc.) from a time point when the valid term of the advertising campaign provided to the display device 200 expires arrives may occur, while the advertising campaign is not displayed in the advertisement area 212 included in the UI 211.

According to an embodiment, the electronic device 100 may identify whether an event that a time point before a preset time from a time point when the valid term of the advertising campaign expires arrives occurs, based on the valid term of the advertising campaign stored in the display device 200 received from the display device 200 and the time information of the region wherein the display device 200 is located received from the display device 200. If it is identified that an event that a time point before a preset time from a time point when the valid term of the advertising campaign expires arrives occurred, the electronic device 100 may identify that the preset event occurred.

According to an embodiment, an event that a time point within a preset period arrived for an advertising campaign of a time target type may occur. In case an advertising campaign of which time target type has been set exists among the advertising campaigns stored in the electronic device 100, the electronic device 100 may determine whether a preset period arrived for the advertising campaign of which time target type has been set. Here, the electronic device 100 may determine whether the preset period arrived for the advertising campaign of which time target type has been set based on the current time of the region wherein the display device 200 is located. In case the preset period arrived for the advertising campaign of which time target type has been set, the electronic device 100 may identify that the preset event occurred.

If it is identified that the preset event occurred, the electronic device 100 may transmit information about a new advertising campaign for which a new valid term has been set to the display device 200 in operation S370.

Also, the electronic device 100 may determine whether the valid term of the advertising campaign stored in the display device 200 expired based on the time of the region wherein the display device 200 is located, on the basis of the information received from the display device 200. If it is identified that the valid term of the advertising campaign stored in the display device 200 expired, the electronic device 100 may transmit the information about the advertising campaign for which a new valid term has been set to the display device 200.

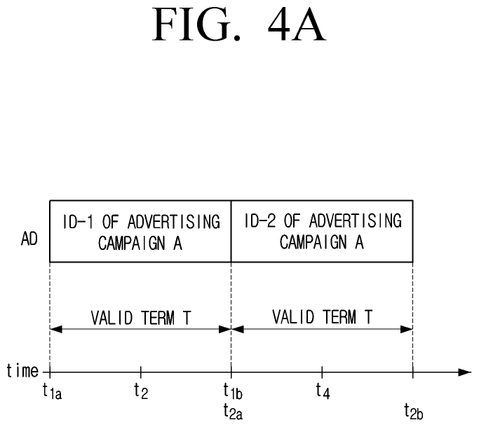

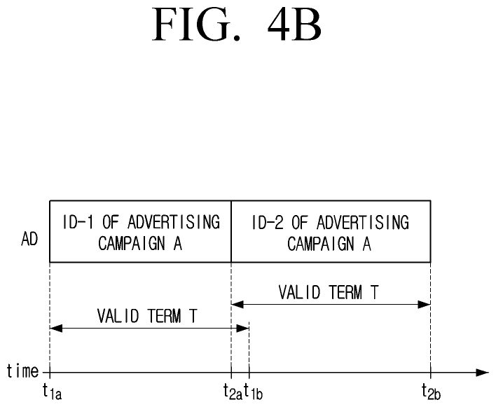

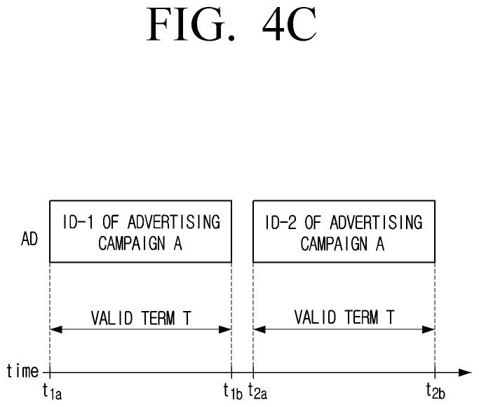

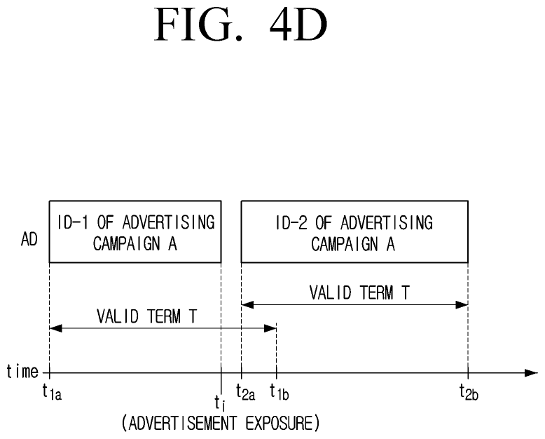

FIG. 4A to FIG. 4C are diagrams for illustrating a preset event according to a valid term of an advertising campaign according to an embodiment of the disclosure.

Referring to FIG. 4A to FIG. 4C, the valid term of the advertising campaign A may be set as T. As an advertising campaign should be exposed at the display device 200 only within a specific period, it has a valid term, and only when the advertising campaign is exposed at the display device 200 within the valid term, it can be regarded that a valid advertisement was exposed.

The electronic device 100 may calculate the current time of the region wherein the display device 200 is located, based on the time information of the region wherein the display device 200 is located received from the display device 200. Also, the electronic device may calculate the time of the region wherein the display device 200 is located when transmitting information about an advertising campaign. The electronic device 100 may transmit information about an advertising campaign for which the time of the region wherein the display device 200 is located when transmitting the information about the advertising campaign belongs within the valid term to the display device 200.

Specifically, the electronic device 100 may transmit information about the advertising campaign A (identification information 1) for which a valid term T between a time point t₁ₐ and a time point t_{1b} has been set to the display device 200. In this case, the electronic device 100 may store the information about the advertising campaign (e.g.: the identification information of the advertising campaign, the valid term of the advertising campaign) transmitted to the display device 200.

According to an embodiment, as in FIG. 4A, the electronic device 100 may determine whether the time point t_{1b} when the valid term of the advertising campaign A (identification information 1) expires arrived, based on the local time of the display device 200. In case the local time of the display device 200 arrived at the time point t_{1b} when the valid term of the advertising campaign A (identification information 1) expires, the electronic device 100 may transmit information about a new advertising campaign A (identification information A2) for which a valid term T between a time point t₂ₐ and a time point t_{2b} has been set to the display device 200.

According to an embodiment, as in FIG. 4B, the electronic device 100 may determine whether a time point (e.g.: t₂ₐ) before a preset time (e.g.: 5 minutes, etc.) from the time point t_{1b} when the valid term of the advertising campaign A (identification information 1) expires arrived, based on the local time of the display device 200. In case it was identified that the local time of the display device 200 arrived at the time point (e.g.: t₂ₐ) before the preset period (e.g.: 5 minutes, etc.) from the time point t_{1b} when the valid term of the advertising campaign A (identification information 1) expires, the electronic device 100 may transmit information about the new advertising campaign A (identification information A2) for which the valid term T between the time point t₂ₐ and the time point t_{2b} has been set to the display device 200.

According to an embodiment, as in FIG. 4C, the electronic device 100 may receive information indicating that the valid term of the advertising campaign A (identification information 1) expired from the display device 200, after the valid term of the advertising campaign A (identification information 1) expired. Alternatively, the electronic device 100 may determine whether the valid term of the advertising campaign A (identification information 1) stored in the display device 200 expired based on the time of the region wherein the display device 200 is located, on the basis of the time information of the display device 200 included in the information received from the display device 200 and the valid term of the advertising campaign A (identification information 1) stored in the display device 200. In this case, the electronic device 100 may transmit information about the new advertising campaign A (identification information A2) for which the valid term T between the time point t₂ₐ and the time point t_{2b} has been set to the display device 200. This is because, as communication between the electronic device 100 and the display device 200 is not smooth, a case wherein information about an advertising campaign is not transmitted in advance may occur, and the above feature is for complementing such a case.

FIG. 4D is a diagram for illustrating a preset event according to an event that an advertising campaign was exposed within the valid term of the advertising campaign according to an embodiment of the disclosure.

Referring to FIG. 4D, according to an embodiment, if a user command for displaying the UI 211 including the advertisement area 212 is received at a time point tᵢ within the valid term, the display device 200 may display the advertising campaign A (identification information 1) in the advertisement area 212. In this case, the display device 200 may transmit information indicating that the advertising campaign A was displayed to the electronic device 100. After the time point tᵢ, even if the UI 211 including the advertisement area 212 is displayed again at a time point within the valid term at the display device 200, the advertising campaign A (identification information 1) may not be displayed in the advertisement area 212. In this case, a different advertising campaign from the advertising campaign A (identification information 1) may be displayed. This is for correctly counting the number of times that an advertising campaign is exposed at the electronic device 100.

If information indicating that the advertising campaign A was displayed is received from the display device 200, the electronic device 100 may identify that an event that the advertising campaign A is displayed on the display device 200 occurred. Then, the electronic device 100 may transmit information about the new advertising campaign A (identification information A2) for which the valid term T between the time point t₂ₐ and the time point t_{2b} has been set to the display device 200 through the communication unit 110.

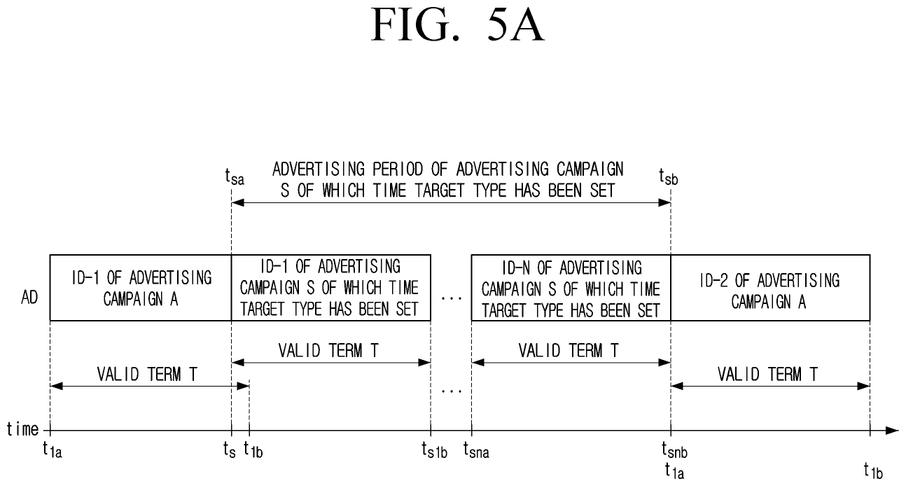

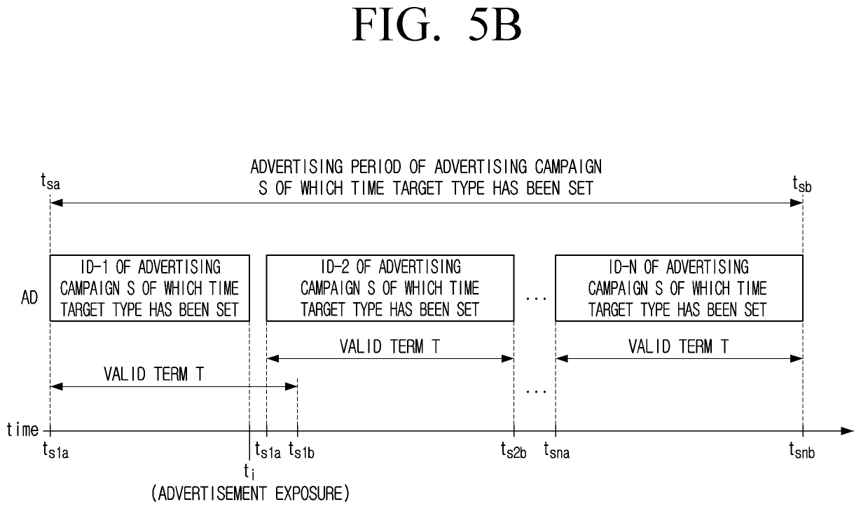

FIG. 5A and FIG. 5B are diagrams for illustrating a preset event according to an advertising campaign of a time target type according to an embodiment of the disclosure.

Referring to FIG. 5A and FIG. 5B, in the electronic device 100 according to an embodiment of the disclosure, information on a plurality of advertising campaigns may be stored. Also, in the electronic device 100, information about an advertising campaign of which time target type has been set may be stored. The information about the advertising campaign may include information indicating whether a time target type of the advertising campaign has been set, and in case the time target type has been set, information on a preset period.

Here, the advertising campaign of which time target type has been set refers to an advertising campaign that was set to be provided in a time zone (i.e., a preset period) desired by the advertiser. Here, in the case of the advertising campaign of which time target type has been set, it is exposed limited to the preset period, and its priority of being exposed may have been set to be higher than an advertising campaign of which time target type has not been set. Here, the preset period may be determined according to the advertiser's selection, but the valid term may not be determined by the advertiser, but may be granted uniformly to each advertising campaign by the electronic device 100 for determining the number of times that the advertising campaign is exposed.

Hereinafter, with reference to FIG. 5A and FIG. 5B, explanation will be described based on the assumption that an advertising campaign S of which time target type has been set exists in the electronic device 100, and for the advertising campaign S, a preset period between a starting point tₛₐ and an ending point t_{sb} has been set.

For example, as in FIG. 5A, the display device 200 may have stored the advertising campaign A (identification information 1) for which a valid term between the time point t₁ₐ and the time point t_{1b} has been set.

If it is determined that the time of the region wherein the display device 200 is located arrived at the starting point tₛₐ of the preset period of the advertising campaign S of which time target type has been set, based on the information received from the display device 200, the electronic device 100 may transmit information about a new advertising campaign S (identification information S1) of which time target type has been set to the display device 200. Here, the information about the advertising campaign S (identification information S1) may include a valid term (a valid term between a time point tₛ₁ₐ and a time point t_{s1b}) set for the advertising campaign S (identification information S1).

In this case, the display device 200 may display the advertising campaign S (identification information S1) in the advertisement area 212 after the time point tₛ₁ₐ.

Also, if it is determined that the time of the region wherein the display device 200 is located arrived at the ending point t_{s1b} of the valid term of the advertising campaign S (identification information S1) of which time target type has been set, based on the information received from the display device 200, the electronic device 100 may transmit information about an advertising campaign S (identification information S2) having a new valid term to the display device 200.

Meanwhile, if it is determined that the time of the region wherein the display device 200 is located arrived at the ending point t_{sb} of the preset period of the advertising campaign S of which time target type has been set, based on the information received from the display device 200, the electronic device 100 may transmit information about the new advertising campaign A (identification information A2) having a new valid term to the display device 200.

As another example, as in FIG. 5B, if a user command for displaying a UI 121 including an advertisement area 122 at a time point tᵢ within the valid term (the valid term between the time point tₛ₁ₐ and the time point t_{s1b}) set for the advertising campaign S (identification information S1) is received at the display device 200, the display device 200 may display the advertising campaign S (identification information S1) in the advertisement area 122.

In this case, the display device 200 may transmit information indicating that the advertising campaign S (identification information S1) was displayed to the electronic device 100. When the information indicating that the advertising campaign S (identification information S1) was displayed is received from the display device 200, the electronic device 100 may identify that an event that the advertising campaign S is displayed on the display device 200 occurred. Then, the electronic device 100 may transmit information about the new advertising campaign S (identification information S2) for which a new valid term has been set to the display device 200 through the communication unit 110.

As a more specific example, explanation will be described based on the assumption of a case wherein an advertising campaign A (period: Jan. 1, 2021-Jan. 25, 2021) and an advertising campaign B (period: Jan. 20, 2021-Feb. 28, 2021) that were not set as time target types are stored in the electronic device 100, and also, an advertising campaign S (period: 17: 30-21:00 on Feb. 7, 2021, or from the start to the end of “the NFL Super Bowl”) that was set as a time target type is stored in the electronic device 100.

When request information for registration of the display device 200 is received from the display device 200 on Jan. 19, 2021, the electronic device 100 may identify whether the display device 200 is a device that was previously registered based on the received request information and pre-stored registration information.

If the display device 200 is a new display device that was not previously registered, the electronic device 100 may transmit information about the advertising campaign A of which valid term did not expire (including the valid term for the advertising campaign A) to the display device 200.

When the time reached 24:00 on January 25 which is the expiration point of the valid term (or a time point before a preset time from the expiration point) of the information about the advertising campaign A transmitted to the display device 200, the electronic device 100 may transmit information about the advertising campaign B of which valid term did not expire to the display device 200. In this case, the display device 200 may store the received information about the advertising campaign B in the memory 230, and update the information.

By a method as above, information on an advertising campaign of which valid term did not expire may be updated in the display device 200, and at 17:29 on February 7, information about the advertising campaign B of which valid term did not expire may be stored in the display device 200. After 17:29, the valid term of the information about the advertising campaign B has not expired, and thus the advertising campaign is valid. However, when it becomes 17:30, “the NFL Super Bowl” starts, and thus the electronic device 100 may transmit information about the advertising campaign S to the display device 200 right before 17:30.

Although the valid term of the information about the advertising campaign B has not expired, the display device 200 may update the information about the advertising campaign to the information about the advertising campaign S (identification information S1) received from the electronic device 100.

If the advertising campaign S (identification information S1) is exposed before “the NFL Super Bowl” ends at the display device 200, the electronic device 100 may transmit information about a new advertising campaign S (identification information S2) having a new valid term to the display device 200. The display device 200 may store the received information about the new advertising campaign S (identification information S2) in the memory 230, and update the information.

Afterwards, when “the NFL Super Bowl” ends at 21:00, the display device 200 may not display the stored advertising campaign S (identification information S2) in the advertisement area 122. Right before 21:00, the electronic device 100 may transmit information about a new advertising campaign B for which a new valid term has been set to the display device 200. In this case, the display device 200 may store the received information about the advertising campaign B in the memory 230, and update the information.

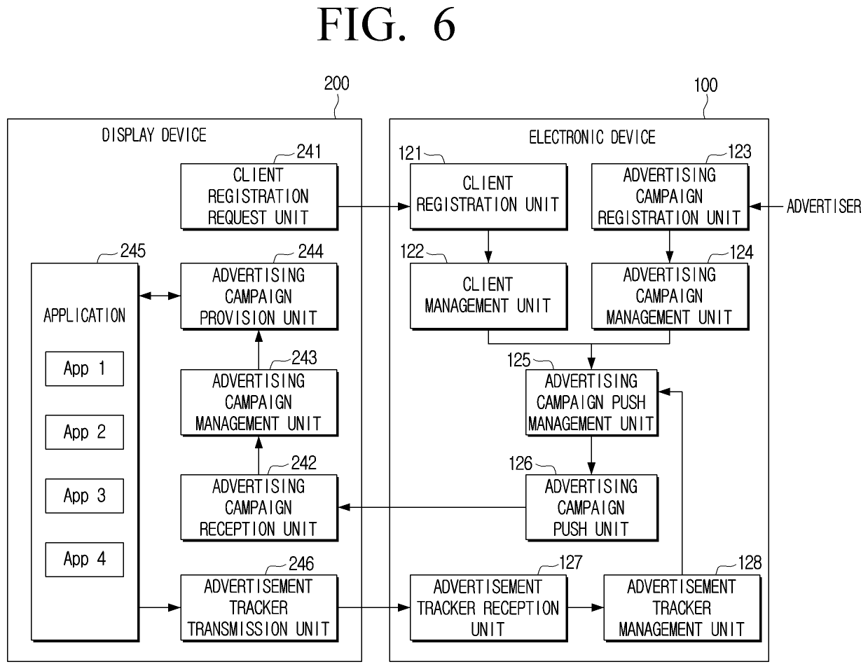

FIG. 6 is a diagram for illustrating detailed modules of each device according to an embodiment of the disclosure.

Referring to FIG. 6, the electronic device 100 may include a client registration unit 121, a client management unit 122, an advertising campaign registration unit 123, an advertising campaign management unit 124, an advertising campaign push management unit 125, an advertising campaign push unit 126, an advertisement tracker reception unit 127, and an advertisement tracker management unit 128. Here, each module included in the electronic device 100 may be a program or an instruction stored in the processor 120 or the memory 130 (refer to FIG. 7), and may be executed by the processor 120.

The client registration unit 121 may receive a registration request of the display device 200 from the display device 200 through the communication unit 110, and transmit the received request information for the display device 200 to the client management unit 122. Here, the request information may include at least one of the identification information (identifier; ID) of the display device 200, the network address of the display device 200, information on the advertisement area 212 exposed at the display device 200 (the size of the advertisement area 212, etc.), information on the region wherein the display device 200 is located, time information of the region wherein the display device 200 is located, or information about an advertising campaign stored in the display device 200 (e.g.: identification information (ID) of the advertising campaign, the valid term, etc.).

The client management unit 122 may store the information on the display device 200 received from the client registration unit 121 in the memory 130. Then, the client management unit 122 may transmit the information on the display device 200 to the advertising campaign push management unit 125. The client management unit 122 may identify whether the display device 200 is in a state of being capable of receiving information about an advertising campaign (i.e., an activated state). For example, the client management unit 122 may transmit a message for requesting a response to each the registered display devices 200, identify a display device 200 from which a response message was received through the communication unit 110 as an activated state, and identify a display device 200 from which a response message was not received as an inactivated state. When a request is received from the advertising campaign push management unit 125, the client management unit 122 may transmit information on the display device 200 in an activated state among the plurality of display devices to the advertising campaign push management unit 125.

The advertising campaign registration unit 123 may receive information about an advertising campaign from the advertiser (or the advertiser side) through the communication unit 110, and transmit the received information about the advertising campaign to the advertising campaign management unit 124.

Here, the information about the advertising campaign may include information on whether a time target type has been set for the advertising campaign by the advertiser. Here, in the case of an advertising campaign of which time target type has been set, the advertising unit cost may be higher than an advertising campaign of which time target type has not been set.

Also, the information about the advertising campaign may be received through a real time bidding method, or received from an electronic device of the advertiser (or the advertiser side) who purchased the advertisement area. The real time bidding method means a method of being provided with bidding prices from advertisers who participated in an auction (i.e., participated in a bidding), and selecting a winner among the advertisers based on the bidding prices.

The advertising campaign management unit 124 may store information about a new advertising campaign received from the advertising campaign registration unit 123 in the memory 130, and transmit the information to the advertising campaign push management unit 125.

The advertising campaign management unit 124 may compare the valid terms of the registered advertising campaigns and the current time, and identify whether the registered advertising campaigns are in a valid state. The advertising campaign management unit 124 may transmit information about an advertising campaign of which valid term is right before expiration (i.e., a time point before a preset time from the expiration point of the valid term) to the advertising campaign push management unit 125. When there is a request from the advertising campaign push management unit 125, the advertising campaign management unit 124 may transmit information about valid advertising campaigns to the advertising campaign push management unit 125.

The advertising campaign push management unit 125 may receive information on an activated display device 200 from the client management unit 122, and receive information about valid advertising campaigns from the advertising campaign management unit 124. The advertising campaign push management unit 125 may select an advertising campaign of which valid term did not expire and of which advertising unit cost is the highest among the at least one advertising campaign based on the information about the activated display device 200 and the information about the valid advertising campaigns, and transmit information about the selected advertising campaign and the information about the activated display device 200 to the advertising campaign push unit 126.

Meanwhile, when the advertising campaign push management unit 125 receives information about a new advertising campaign from the advertising campaign management unit 124, it may identify whether time target information has been set for the advertising campaign based on the received information about the advertising campaign. In case time target information has been set for the advertising campaign, the advertising campaign push management unit 125 may request information about the activated display device 200 for which time targeting is possible to the client management unit 122, and receive information about the display device 200 from the client management unit 122. In this case, the advertising campaign push management unit 125 may transmit the information about the advertising campaign for which time target information has been set and the received information about the display device 200 to the advertising campaign push unit 126.

When the advertising campaign push management unit 125 receives information about an advertising campaign of which valid term is right before expiration (i.e., a time point before a preset time from the expiration point of the valid term) from the advertising campaign management unit 124, the advertising campaign push management unit 125 may transmit information about the display device 200 storing the received information about the advertising campaign to the advertising campaign push unit 126 together with information about a new advertising campaign having a new valid term.

When the advertising campaign push management unit 125 receives advertisement exposure information from the advertisement tracker management unit 128, it may transmit information about the display device 200 that exposed the advertising campaign and the information about the new advertising campaign having a new valid term to the advertising campaign push unit 126.

The advertising campaign push unit 126 may transmit the information about the advertising campaign to the display device 200 through the communication unit 110, by using the information about the display device 200 and the information about the advertising campaign received from the advertising campaign push management unit 125.

The advertising campaign push unit 126 may identify display devices 200 from which information about advertising campaigns is not transmitted as an inactivated state in a list for display devices 200 that should transmit information about advertising campaigns, and transmit a list for the display devices 200 in an inactivated state to the client management unit 122.

The advertisement tracker reception unit 127 may receive advertisement tracker information from the display device 200, and transmit the received advertisement tracker information to the advertisement tracker management unit 128. Here, the advertisement tracker information may include information indicating whether an advertising campaign was exposed at the display device 200 (or whether a user selected an advertising campaign exposed at the display device 200).

The advertisement tracker management unit 128 may identify whether an advertisement was exposed based on the received advertisement tracker information. In case it is identified that an advertisement was exposed (i.e., in the case of an impression tracker), the advertisement tracker management unit 128 may transmit the advertisement exposure information to the advertising campaign push management unit 125.

The display device 200 may include a client registration request unit 241, an advertising campaign reception unit 242, an advertising campaign management unit 243, an advertising campaign provision unit 244, an application 245, and an advertisement tracker transmission unit 246. Here, each module included in the display device 200 may be a program or an instruction stored in the processor 240 or the memory 230, and may be executed by the processor 240.

The client registration request unit 241 may request registration of the display device 200 to the electronic device 100 through the communication unit 220 for receiving an advertising campaign from the electronic device 100. As an example, when the display device 200 is turned on, the client registration request unit 241 may transmit request information to the electronic device 100 through the communication unit 220.

The advertising campaign reception unit 242 may receive information about advertising campaigns from the electronic device 100 through the communication unit 220, and transmit the received information about the advertising campaigns to the adverting campaign management unit 243.

The adverting campaign management unit 243 may store the received information about the advertising campaigns in the memory 230. The adverting campaign management unit 243 may identify an advertising campaign for which the time of the region wherein the display device 200 is located is within the valid term (i.e., a valid advertising campaign) among the stored information about the advertising campaigns, and transmit information about the identified advertising campaign to the advertising campaign provision unit 244. In case there are one or more identified valid advertising campaigns, the adverting campaign management unit 243 may transmit information on advertising campaigns of which time targets have been set to the advertising campaign provision unit 244.

The advertising campaign provision unit 244 may transmit the information about the valid advertising campaigns to the application 245 according to an advertisement request of the application 245.

The application (or UI) 245 may include a plurality of applications. At least one of the plurality of applications may include an advertisement area. The application 245 may be executed according to a user command or displayed on the display 210, and in case an advertisement area is displayed, the application 245 may request information about valid advertising campaigns to the advertising campaign provision unit 244. When the information about the valid advertising campaigns are received from the advertising campaign provision unit 244, the application 245 may display an advertising campaign in the advertisement area by using the information about the advertising campaigns.

The advertisement tracker transmission unit 246 may detect whether an advertising campaign is displayed (i.e., exposed), or a user command (e.g.: a click, a hovering, etc.) for selecting an advertising campaign is received at the application 245, and transmit the detected information to the electronic device 100 through the communication unit 220.

FIG. 7 is a diagram for illustrating additional components of an electronic device according to an embodiment of the disclosure.

Referring to FIG. 7, the electronic device 100 may further include at least one of a memory 130, an input interface 140, or an output interface 150 other than the communication unit 110 and the processor 120.

The memory 130 is a component for storing an operating system (OS) for controlling the overall operations of the components of the electronic device 100, and various kinds of data related to the components of the electronic device 100. For this, the memory 130 may consist of hardware that temporarily or permanently stores data or information. For example, the memory 130 may be implemented as at least one hardware among a non-volatile memory, a volatile memory, a flash memory, a hard disk drive (HDD) or a solid state drive (SSD), a RAM, a ROM, etc.

In the memory 130, at least one instruction, program, or data necessary for the operations of the electronic device 100 or the processor 120 may be stored. Here, the instruction is a code unit instructing the operations of the electronic device 100 or the processor 120, and it may have been drafted in a machine language which is a language that can be understood by a computer. The program may be a set of a series of instructions (an instruction set) performing specific operations in work units. The data may be state information in bit or byte units that can indicate characters, numbers, images, etc.

In the memory 130, information about an advertising campaign of an advertiser may be stored.

The input interface 140 may receive various kind of user commands and transmit them to the processor 120. That is, the processor 120 may recognize a user command input from a user through the input interface 140. Here, a user command may be implemented by various methods such as a user's touch input (a touch panel), a key (a keyboard) or a button (a physical button or a mouse, etc.) input, a user voice (a microphone), etc.

The output interface 150 is a component that can output information, and for example, the output interface 150 may include at least one of a display or a speaker. The display is a device that outputs information or data in a visual form. The display may display an image frame in one area or the entire area of the display that can be driven in pixels. At least a part of the display may be combined with at least one of the front surface area, the side surface areas, or the rear surface area of the electronic device 100 in the form of a flexible display. The flexible display may be characterized in that it can be bent, curved, or rolled without a damage through a substrate which is thin and flexible like paper. The speaker may directly output not only various kinds of audio data for which various processing jobs such as decoding or amplification, and noise filtering were performed by an audio processor (not shown), but also various kinds of notification sounds or voice messages as sounds.

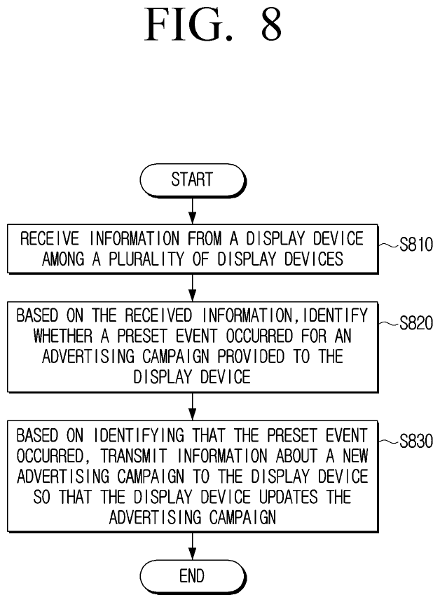

FIG. 8 is a diagram for illustrating a flow chart according to an embodiment of the disclosure.

Referring to FIG. 8, a control method for the electronic device 100 may include receiving information from a display device 200 among a plurality of display devices 200 (S810), identifying whether a preset event occurred for an advertising campaign provided to the display device 200 based on the received information (S820), and based on identifying that the preset event occurred, transmitting information about a new advertising campaign to the display device 200 so that the display device 200 updates the advertising campaign (S830).

Specifically, in the control method for the electronic device 100, information may be received from a display device 200 among the plurality of display devices 200 in operation S810.

Then, it may be identified whether a preset event occurred for an advertising campaign provided to the display device 200 based on the received information in operation S820.

Specifically, in the identifying whether the preset event occurred, based on identification information of an advertising campaign received from the display device 200, the valid term of the advertising campaign may be identified among the valid terms of each of the plurality of advertising campaigns stored in the electronic device 100. In this case, based on the identified valid term of the advertising campaign and time information of a region wherein the display device 200 is located received from the display device 200, it may be identified whether the preset event related to the valid term of the advertising campaign occurred.

According to an embodiment, in the identifying whether the preset event occurred, based on receiving request information from the display device 200 according to turning-on of the display device 200, it may be identified whether a preset event occurred regarding the advertising campaign provided to the display device 200 based on the received request information. Here, the request information may include identification information of the advertising campaign and time information of a region wherein the display device 200 is located.

According to an embodiment, the preset event may include an event that the valid term of the advertising campaign provided to the display device 200 expired. In this case, in the identifying whether the preset event occurred, based on the identified valid term of the advertising campaign and the time information of the region wherein the display device 200 is located received from the display device 200, it may be identified whether the valid term of the advertising campaign expired.

According to an embodiment, the preset event may include an event that a time point before a preset time from a time point when the valid term of the advertising campaign provided to the display device 200 expired arrives. In this case, in the identifying whether the preset event occurred, based on the identified valid term of the advertising campaign and the time information of the region wherein the display device 200 is located received from the display device 200, it may be identified whether the time point arrived.

According to an embodiment, the preset event may include an event that the advertising campaign is displayed on the display device 200. In this case, in the identifying whether the preset event occurred, based on receiving information indicating that the advertising campaign was displayed from the display device 200, it may be identified that the event that the advertising campaign is displayed on the display device 200 occurred.

According to an embodiment, in the identifying whether the preset event occurred, it may be identified whether a new advertising campaign set to be provided during a preset period exists among the plurality of advertising campaigns.

Then, if it is identified that the preset event occurred, information about a new advertising campaign may be transmitted to the display device 200 so that the display device 200 updates the advertising campaign in operation S830.

Here, the new advertising campaign may be an advertising campaign having a valid term that expires on a different time point from the advertising campaign provided to the display device 200.

According to an embodiment, the preset event may include an event that the valid term of the advertising campaign provided to the display device 200 expired. In this case, in the transmitting to the display device 200, based on identifying that the valid term of the advertising campaign expired, the information about the new advertising campaign may be transmitted to the display device 200.

According to an embodiment, the preset event may include an event that a time point before a preset time from a time point when the valid term of the advertising campaign provided to the display device 200 expires arrives. In this case, in the transmitting to the display device 200, based on identifying that the time point arrived, the information about the new advertising campaign may be transmitted to the display device 200.

According to an embodiment, the preset event may include an event that the advertising campaign is displayed on the display device 200. In this case, in the transmitting to the display device 200, the information about the new advertising campaign may be transmitted to the display device 200.

According to an embodiment, in the transmitting to the display device 200, based on identifying that the time of the region wherein the display device 200 is located corresponds to the preset period based on the time information of the region wherein the display device 200 is located received from the display device 200, the information about the new advertising campaign set to be provided during the preset period may be transmitted to the display device 200.

The various embodiments of the disclosure may be implemented as software including instructions stored in machine-readable storage media, which can be read by machines (e.g.: computers). The machines refer to devices that call instructions stored in a storage medium, and can operate according to the called instructions, and the devices may include an electronic device according to the aforementioned embodiments (e.g.: an electronic device 100). In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. Here, the term ‘non-transitory’ only means that a storage medium does not include signals, and is tangible, but does not indicate whether data is stored in the storage medium semi-permanently or temporarily.

Also, a method according to the various embodiments may be provided while being included in a computer program product. A computer program product is a product, and it can be traded between a seller and a buyer. A computer program product can be distributed in the form of a storage medium that is readable by machines (e.g.: a compact disc read only memory (CD-ROM)), or distributed on-line through an application store (e.g.: Play Store™) In the case of on-line distribution, at least a portion of a computer program product may be stored in a storage medium such as the server of the manufacturer, the server of the application store, and the memory of the relay server at least temporarily, or may be generated temporarily.

In addition, each of the components according to the various embodiments (e.g.: a module or a program) may consist of a singular object or a plurality of objects. Also, among the aforementioned corresponding sub components, some sub components may be omitted, or other sub components may be further included in the various embodiments. Alternatively or additionally, some components (e.g.: a module or a program) may be integrated as an object, and perform the functions that were performed by each of the components before integration identically or in a similar manner. Operations performed by a module, a program, or other components according to the various embodiments may be executed sequentially, in parallel, repetitively, or heuristically. Or, at least some of the operations may be executed in a different order or omitted, or other operations may be added.

What is claimed is:

1. An electronic device, comprising:
a communication unit; and
a processor configured to:
receive information from a display device, among a plurality of display devices, through the communication unit, the display device being configured to display an advertising campaign based on a user command input into the display device,
identify whether a preset event for the advertising campaign on the display device occurred based on the received information, and
based on the preset event being identified as having occurred, transmit information about a new advertising campaign to the display device through the communication unit so that the display device is provided with an updated advertising campaign.

2. The electronic device of claim 1, further comprising:
a memory to store information on valid terms for each of a plurality of advertising campaigns, respectively,
wherein the processor is configured to:
based on identification information of the advertising campaign being received from the display device, identify a respective valid term of the advertising campaign among the valid terms of the plurality of advertising campaigns, and
based on the respective valid term of the advertising campaign being identified and time information of a region in which the display device is located received from the display device, identify whether the preset event occurred in relation to the respective valid term of the advertising campaign.

3. The electronic device of claim 2,
wherein the preset event includes an event that the respective valid term of the advertising campaign which is provided to the display device has expired, and
the processor is configured to:
based on the respective valid term of the advertising campaign and the time information of the region in which the display device is located received from the display device, identify whether the respective valid term of the advertising campaign has expired, and
based on the respective valid term of the advertising campaign being identified as expired, transmit the information about the new advertising campaign to the display device through the communication unit.

4. The electronic device of claim 2,
wherein the preset event comprises an event that a time point before a preset time from a time point when the respective valid term of the advertising campaign provided to the display device expires arrives, and
the processor is configured to:
based on the respective valid term of the advertising campaign and the time information of the region in which the display device is located received from the display device, identify whether the time point arrived, and
based on the time point being identified as having arrived, transmit the information about the new advertising campaign to the display device through the communication unit.

5. The electronic device of claim 1,
wherein the preset event comprises an event that the advertising campaign is displayed on the display device, and
the processor is configured to:
based on receiving information indicating that the advertising campaign was displayed from the display device, identify that the event that the advertising campaign is displayed on the display device occurred, and
transmit the information about the new advertising campaign to the display device through the communication unit.

6. The electronic device of claim 1,
wherein the new advertising campaign has a valid term that expires on a different time point from the advertising campaign provided to the display device.

7. The electronic device of claim 2,
wherein the processor is configured to:
identify whether a new advertising campaign set to be provided during a preset period exists among the plurality of advertising campaigns, and
based on identifying that a time of the region in which the display device is located corresponds to the preset period based on the time information of the region in which the display device is located received from the display device, transmit the information about the new advertising campaign set to be provided during the preset period to the display device through the communication unit.

8. The electronic device of claim 1,
wherein the processor is configured to:
based on receiving request information from the display device through the communication unit according to turning-on of the display device, identify whether the preset event involving the display of the advertising campaign on the display device occurred based on the received request information, and
the request information comprises identification information of the advertising campaign and time information of a region in which the display device is located.

9. A control method for an electronic device, the method comprising:
receiving information from a display device among a plurality of display devices, the display device being configured to display an advertising campaign based on a user command input into the display device;
identifying whether a preset event for the advertising campaign on the display device occurred based on the received information; and
based on the preset event being identified as having occurred, transmitting information about a new advertising campaign to the display device so that the display device is provided with an updated advertising campaign.

10. The control method of claim 9,
wherein the identifying whether the preset event occurred comprises:
based on identification information of the advertising campaign received from the display device, identifying a respective valid term of the advertising campaign among valid terms of the plurality of advertising campaigns that are stored in the electronic device; and
based on the respective valid term of the advertising campaign being identified and time information of a region in which the display device is located received from the display device, identifying whether the preset event occurred in relation to the valid term of the advertising campaign.

11. The control method of claim 10,
wherein the preset event comprises an event that the respective valid term of the advertising campaign which is provided to the display device has expired, and
the identifying whether the preset event occurred comprises:
based on the respective valid term of the advertising campaign and the time information of the region in which the display device is located received from the display device, identifying whether the respective valid term of the advertising campaign expired, and
the transmitting to the display device comprises:
based on the respective valid term of the advertising campaign being identified as expired, transmitting the information about the new advertising campaign to the display device.

12. The control method of claim 10,
wherein the preset event comprises an event that a time point before a preset time from a time point when the respective valid term of the advertising campaign provided to the display device expires arrives, and
the identifying whether the preset event occurred comprises:
based on the respective valid term of the advertising campaign and the time information of the region in which the display device is located received from the display device, identifying whether the time point arrived, and
the transmitting to the display device comprises:
based on the time point being identified as having arrived, transmitting the information about the new advertising campaign to the display device.

13. The control method of claim 9,
wherein the preset event comprises an event that the advertising campaign is displayed on the display device, and
the identifying whether the preset event occurred comprises:
based on receiving information indicating that the advertising campaign was displayed from the display device, identifying that the event that the advertising campaign is displayed on the display device occurred, and
the transmitting to the display device comprises:
transmitting the information about the new advertising campaign to the display device.

14. The control method of claim 9,
wherein the new advertising campaign has a valid term that expires on a different time point from the advertising campaign provided to the display device.

15. The control method of claim 10,
wherein the identifying whether the preset event occurred comprises:
identifying whether a new advertising campaign set to be provided during a preset period exists among the plurality of advertising campaigns, and
the transmitting to the display device comprises:
based on identifying that a time of the region in which the display device is located corresponds to the preset period based on the time information of the region in which the display device is located received from the display device, transmitting the information about the new advertising campaign set to be provided during the preset period to the display device.

16. The electronic device of claim 9,
wherein the identifying whether the preset event occurred comprises:
based on receiving request information from the display device according to turning-on of the display device, identifying whether the preset event involving the display of the advertising campaign on the display device occurred based on the received request information, and
the request information comprises identification information of the advertising campaign and time information of a region in which the display device is located.

17. A non-transitory computer readable recording medium storing computer instructions that cause an electronic device to perform an operation when executed by a processor of the electronic device, wherein the operation comprises;
receiving information from a display device among a plurality of display devices, the display device being configured to display an advertising campaign based on a user command input into the display device;
identifying whether a preset event for the advertising campaign on the display device occurred based on the received information; and
based on the preset event being identified as having occurred, transmitting information about a new advertising campaign to the display device so that the display device is provided with an updated advertising campaign.

18. The medium of claim 17,
wherein the identifying whether the preset event occurred comprises:
based on identification information of the advertising campaign received from the display device, identifying a respective valid term of the advertising campaign among valid terms of the plurality of advertising campaigns that are stored in the electronic device; and
based on the respective valid term of the advertising campaign being identified and time information of a region in which the display device is located received from the display device, identifying whether the preset event occurred in relation to the valid term of the advertising campaign.

19. The medium of claim 18,
wherein the preset event comprises an event that the respective valid term of the advertising campaign which is provided to the display device has expired, and
the identifying whether the preset event occurred comprises:
based on the respective valid term of the advertising campaign and the time information of the region in which the display device is located received from the display device, identifying whether the respective valid term of the advertising campaign expired, and
the transmitting to the display device comprises:
based on the respective valid term of the advertising campaign being identified as expired, transmitting the information about the new advertising campaign to the display device.

20. The medium of claim 18,
wherein the preset event comprises an event that a time point before a preset time from a time point when the respective valid term of the advertising campaign provided to the display device expires arrives, and
the identifying whether the preset event occurred comprises:
based on the respective valid term of the advertising campaign and the time information of the region in which the display device is located received from the display device, identifying whether the time point arrived, and
the transmitting to the display device comprises:
based on the time point being identified as having arrived, transmitting the information about the new advertising campaign to the display device.
